(19) United States
(12) Patent Application Publication
(10) Pub. No.: US 2006/0155545 A1
(43) Pub. Date: Jul. 13, 2006

(54) Multi-source powered audio playback system

(75) Inventor: Michael A. Jayne, Albuquerque, NM (US)

Correspondence Address: Kevin Lynn Wildenstein;Southwest Intellectual Property Services, LLC, Suite 8, 6700-B Jefferson, Albuquerque, NM, 87109, US

(73) Assignee: Hosanna, Inc., Albuquerque, NM (US)

(21) Appl. No.: 11/328,632

(22) Filed: Jan. 10, 2006

Related U.S. Application Data
(60) Provisional application No. 60/642,926, filed on Jan. 11, 2005.

(51) Int. Cl. G10L 21/00

(52) U.S. Cl. 704/272

(57) ABSTRACT

The present invention is a multi-source powered audio playback system which integrates multiple energy charging sources that charge an internal battery, with a digital audio player and an analog audio amplifier and multiple audio outputs. In one embodiment, the present invention includes a mechanical power generating means, rectifier, solar power cell, blocking circuit, external AC/DC charger, blocking circuit, charge control circuit, at least one rechargeable battery pack, a power control circuit, a digital audio player, at least one mass memory device with secure content, voltage regulator circuit, power supply de-coupling circuit, analog audio amplifier, output circuit and a waterproof speaker. The audio content is secured by the elimination of a consumer usable data port and/or password protection. The invention optimally provides an audio output signal that is sufficient for private, room or group use.

### CLAIM OF PRIORITY

The present invention claims priority based upon U.S. Provisional Patent Application No. 60/642,926, filed Jan. 11, 2005, which is hereby incorporated by reference.

### FIELD OF INVENTION

The present invention relates generally to audio transceivers, and more particularly, to a transportable digital audio transceiver powered by multiple independent power sources, adapted to receive and communicate pre-selected digital content, and having selectable audio output configurations, which is preferably useful in large room or group settings.

### BACKGROUND OF THE INVENTION

Digital audio players are well known and in widespread use. A digital audio player typically includes a digital signal processor, a memory, a power source as ear buds or headphones. Various models are available worldwide offered by various manufacturers.

For example, SigmaTel currently manufactures several individual audio decoder chips which features include (but are not limited to): Universal Serial Bus (USB)-connect ability, capable of being powered by different battery sources, MP3 and WMA decoding, LED/LCD display driver, integrated RTC, remote control, FM line-in and control, graphical equalizer, subdirectory support, play list support, analog line-in, microphone line-in, ADPCM voice recording, and headphone amplifier.

The commercial and consumer markets for digital audio playback players becomes more sophisticated and developed around the needs of a consumer market that requires multiple features in a personal audio player. For example, U.S. Pat. No. 6,606,281 B2 describes a digital audio player which has a removable and interchangeable multi-function module that has at least one operating member. The multi-function interchangeable module interoperates with the body of the digital audio player to provide a plurality of features, which include additional memory storage, radio tuner, display, infrared transceiver and wireless transceiver capabilities. However, this invention disclosed in this patent provides a disadvantage because there is a need for a digital audio player that operates from universally available external energy sources, which provides simple reliable function for delivery of audio content in group settings that has not been effectively addressed in the consumer market, particularly for the third world environment.

U.S. Pat. No. 5,835,457 describes an electronic watch that utilizes an energy source that transforms external energy into electric energy and supplies a power supply voltage. This invention establishes a means of powering an electronic watch. The present invention provides an audio playback system that utilizes an energy source that transforms solar, kinetic, or chemical energy into electric energy in quantities that are sufficient to power a group audio playback system.

U.S. Pat. No. 6,678,215 generally describes digital audio devices. An alarm clock is provided that handles downloaded audio files and streaming digital audio files. The user may be provided with an opportunity to subscribe to a content service. In contrast, the present invention serves a much different service because it is optimally configured, in one embodiment, to store and protect and transmit copyrighted content. For example, in one embodiment, the content is loaded and stored in the present invention and is password protected without incorporating any consumer compatible hardware port to download or otherwise modify the stored digital content.

U.S. Pat. No. 6,807,591 describes an invention that provides a method and an apparatus for a multi-function device to enable an data processor to amplify the broadcasting power and perform stereophony by the means of a speaker set.

This invention does not address universal power sourcing that allows the device to be used apart from a power grid.

U.S. Pat. No. 6,737,570 describes an interactive personal audio device that is battery powered and may be carried by a user, for example in the user's palm or pocket. Touch controls may be provided with the personal audio device. The personal audio device may play back audio files such as compact disc or digital audio stream. The user may interject sounds or audio effects onto the ongoing playback of the audio by operating one or more touch operators. This invention is designed for personal use (not group use) and does not utilize multiple universally available energy sources.

What is needed is a digital audio playback system adapted to store digital content on memory (such as re-recordable flash memory, for example) which can be offered to the economically disadvantaged (such as those residing in third-world countries, where it is currently estimated that at least half of all living beings in the world are illiterate and survive on less than $2.00 a day) which can operate primarily on solar power or manually-generated power, but which can also operate on conventional battery power or alternating current power. The system should be designed to transmit an appropriate audio signal containing digital content to an adjacent geographical area so that all listeners in the area may enjoy and learn from the digital content. The audio signal should preferably be optimized for voice clarity rather than musical clarity. It is the primary intent of the present invention to provide such a system to the economically disadvantaged to provide such persons with informational digital content (such as, for example, providing public service messages for the illiterate on potential safety concerns, water sanitizing concerns and how to maintain sanitary living habits). The present invention solves this need.

### SUMMARY OF THE INVENTION

The following summary of the invention is provided to facilitate an understanding of some of the innovative features unique to the present invention, and is not intended to be a full description of variations that may be apparent to those of skill in the art. A full appreciation of the various aspects of the invention can be gained from the entire specification, claims, drawings, and abstract taken as a whole.

The present invention is a portable, multi-source powered audio playback system adapted to integrate one or more power sources to charge an internal battery, the invention having a digital audio player and an analog audio amplifier and multiple audio outputs. In one embodiment, the present invention includes at least one mechanical or manual power generating means, at least one rectifier, at least one solar power cell, at least one blocking circuit, at least one external AC/DC charger, at least one blocking circuit, at least one charge control circuit, at least one rechargeable battery pack, at least one power control circuit, at least one electronic control computer or digital audio transceiver, at least one mass memory device or unit adapted to store secure content, at least one voltage regulator circuit, at least one power supply de-coupling circuit, at least one analog audio amplifier, at least one output circuit and at least one waterproof or otherwise water-resistant speaker, all in electronic communication with each other. In one embodiment, the audio content stored on the memory unit is secured by the elimination of a consumer usable data port and/or through software password protection. In another embodiment, the system is adapted to transmit the digital content through an audio medium capable of broadcast in a large room for group use.

The present invention overcomes the limitations and deficiencies of prior art, which has not addressed the specific requirements of the needs of an audio device that is able to provide sustained audio volume levels adequate for group or room listening, use of multiple universally available energy sources and secure protected audio content.

The novel features of the present invention will become apparent to those of skill in the art upon examination of the following detailed description of the preferred embodiment or can be learned by practice of the present invention. It should be understood, however, that the detailed description of the preferred embodiment and the specific examples presented, while indicating certain embodiments of the present invention, are provided for illustration purposes only because various changes and modifications within the spirit and scope of the invention will become apparent to those of skill in the art from the detailed description, drawings and claims that follow.

### BRIEF DESCRIPTIONS OF THE DRAWINGS

The accompanying figures further illustrate the present invention and, together with the detailed description of the preferred embodiment, assists to explain the general principles according to the present invention.

FIG. 1 is a front plan view of one embodiment of the present invention;

FIG. 2 is a side plan view of the embodiment illustrated in FIG. 1;

FIG. 3 is a front side perspective view of another embodiment of the present invention, illustrating a hinged or otherwise adjustable rear panel which may securely retain one or more solar cells;

FIG. 4 is a rear side perspective view of FIG. 3; and

FIG. 5 is a electronic schematic box illustration of a representative electrical control circuit of the present invention.

Additional aspects of the present invention will become evident upon reviewing the non-limiting embodiments described in the specification and the claims taken in conjunction with the accompanying figures, wherein like reference numerals denote like elements.

### DETAILED DESCRIPTION OF THE PREFERRED EMBODIMENT

Preferred embodiments of the present invention will hereafter be described in detail with reference to the accompanying drawings.

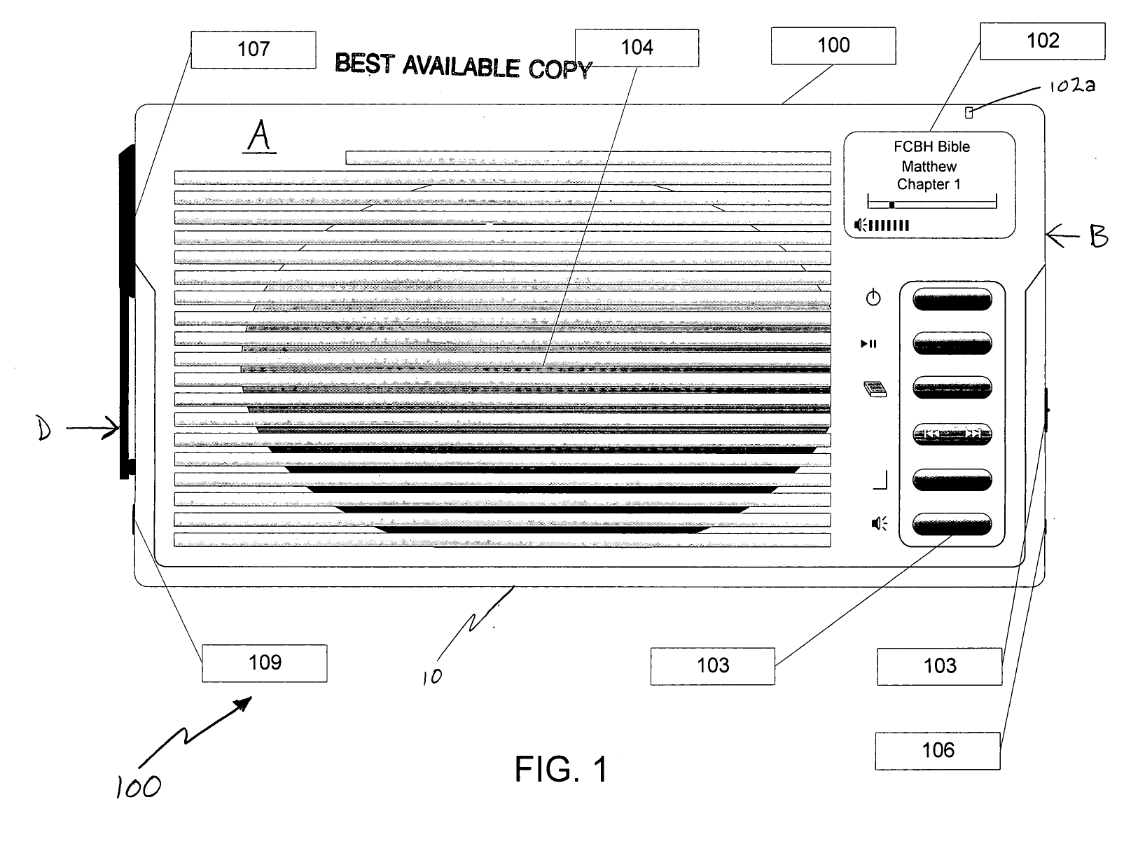

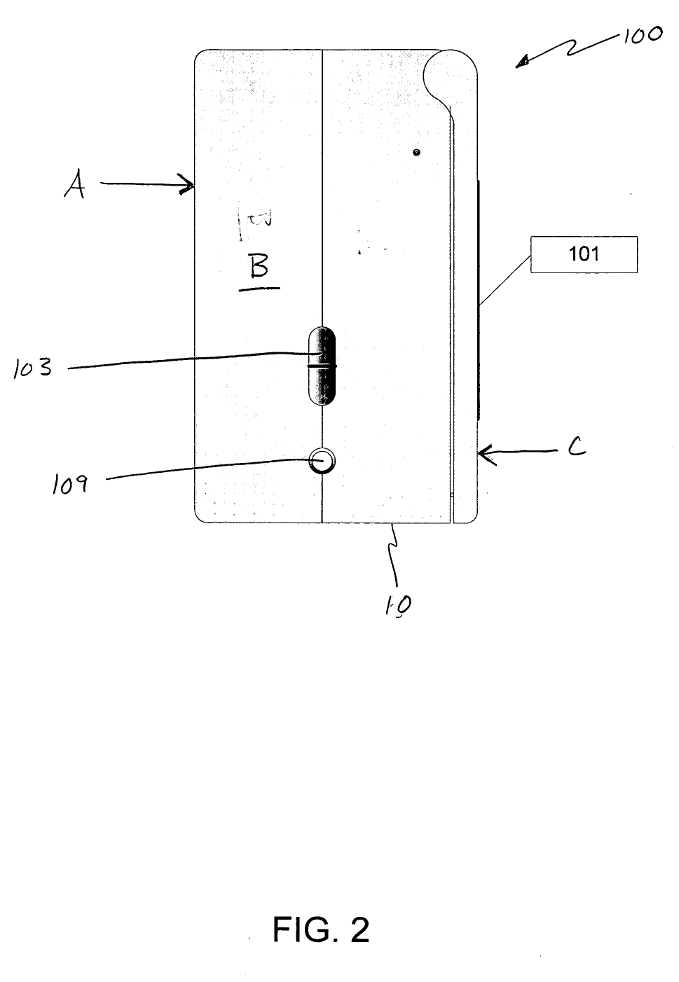

As seen by one representative embodiment illustrated in FIGS. 1 and 2, the present invention is a multi-source powered audio playback or delivery system 100 having an exterior housing 10 which, on a front exterior surface A, securely retains at least one display unit 102, at least one power indicator 102a, one or more control buttons 103, and at least one speaker 104. On another side exterior surface B (as illustrated in FIG. 2), the housing 10 preferably securely retains at least one AC/DC power interface or input jack 109. On another rear exterior surface C (as illustrated in FIG. 2), the housing 10 preferably securely retains at least one solar power cell 101. On another side exterior surface D (as illustrated in FIG. 1), the housing 10 preferably securely retains at least one manually generated power source 107.

As further described below, the present invention is adapted to provide audio playback of digitally secure content with operational elements that allow for stand-alone power sourcing for the single rechargeable battery supply that powers the digital and analog audio circuits.

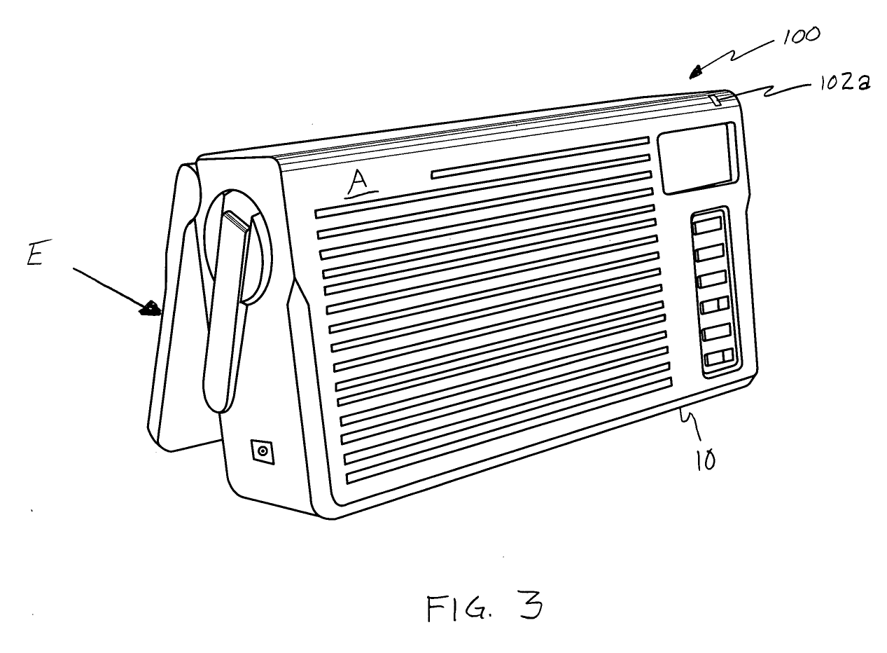

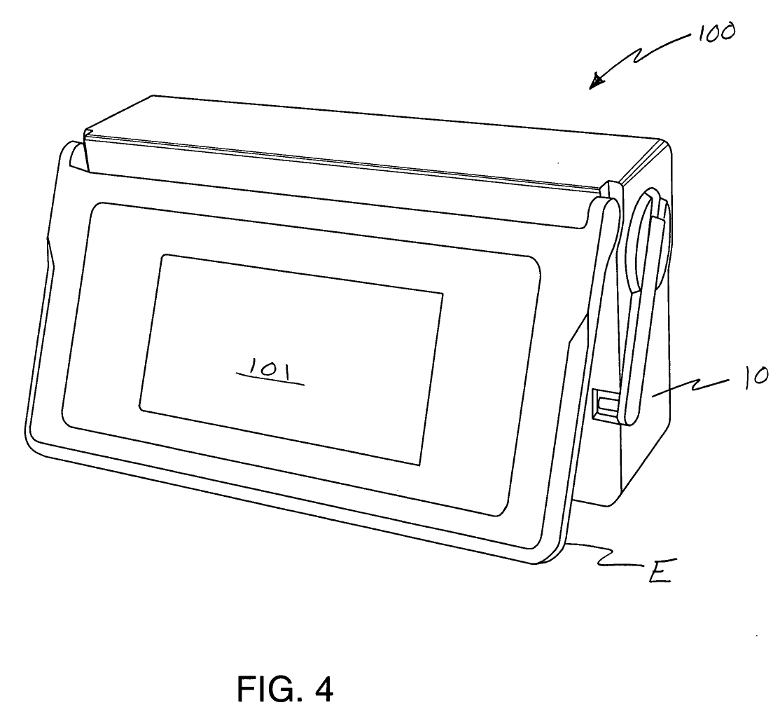

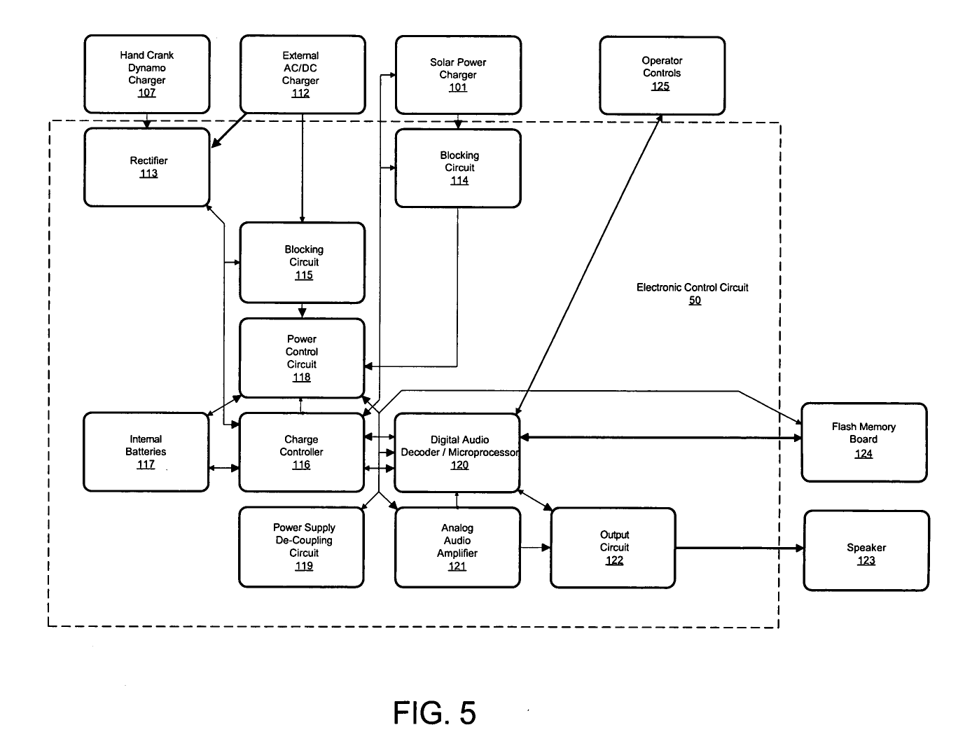

FIGS. 3 and 4 illustrate another preferred embodiment of the present invention. In this embodiment, exterior housing 10 also includes a hinged or otherwise adjustable panel E adapted to securely retain one or more solar cells 101, with each solar cell 101 being in electronic communication with computer or microprocessor 120 (not shown in FIGS. 3 and 4, but operationally illustrated in FIG. 5 and housed within housing 10). While the preferred embodiment shown in FIGS. 3 and 4 disclose a panel E which of substantially the same width and height of the rear surface of exterior housing 10, those of skill in the art will also realize that panel E may be removably secured to the housing 10, so that it may be useful as separately apart from (but still in electrical communication with) housing 10.

FIG. 5 graphically illustrates a representative electronic control circuit 50 (represented by the dashed line box in FIG. 5) adapted for the embodiments illustrated in FIGS. 1-4, according to one aspect of the present invention. The electronic control circuit 50 is adapted to control all functionality and operation of the present invention so that it is in electronic communication with all external controls typically viewable and/or useable by an operator of the system, including each power generating means 107, solar power cells 101, displays 102, AC/DC chargers 112, and each speaker 104.

Returning now to FIG. 5, the electronic control circuit 50 comprises at least one rectifier 113, at least one blocking circuit 115, at least one charge controller 116, at least one internal battery 117, at least one power control circuit 118, at least one power supply de-coupling circuit 119, at least one digital audio decoder or computer 120, at least one analog audio amplifier 121, at least one output circuit 122, and at least one memory unit 124.

According to one aspect of the present invention, system 100 is adapted to charge and re-charge internal battery 117 through one of three selectable power sources: 1) AC/DC power charger circuit 112; 2) a manual power generator 107; or 3) one or more solar panels 101. While only one of these power sources are needed to re-charge internal battery 117, all three in combination provide a unique form of providing power to the present invention which is previously unknown in the radio arts.

In many locations throughout the world, alternating current (AC) power grids or portable gas/diesel generators are available to provide electric power to devices. In instances where the present invention may be operated at these locations, the external AC/DC charger 112 should be the primary power source for charging the internal batteries 117. AC/DC charger 112 is typically on off-the-shelf unit that may be adapted to use depending on the geographical location of the unit. However, a large proportion of the world population does not have access to AC power; in those instances, the solar power charger 101 should be the primary power source. Each solar cell 101 is preferably adapted to provide electrical power to the present system 100 and concurrently, charge the internal batteries 117. If the sun is obscured for extended periods of time (e.g., due to a rainy season), the hand crank dynamo charger 107 is adapted to allow a user to charge the internal batteries 117. In this regard, each rectifier 113 works in conjunction with the hand crank dynamo charger 107 to convert alternating current to direct current. Those skilled in the art will recognize that there are different ways to accomplish rectification. In one embodiment of the present invention, blocking circuit 114 is utilized to isolate the power arising from solar power charger 101 from the hand crank dynamo charger 107 and the external AC/DC charging circuit 112. Blocking circuit 115, as described below, isolates the external AC/DC charging circuit 112. Alternatively, one or more hydrogen fuel cells or methane fuel cells could be incorporated as alternative power sources, each attachable to the system 100.

Preferably, the manual power generator 107 is a rectifiable AC dynamo or a hand crank dynamo capable generating approximately between 200 and 400 milliamps at between 4-6 volts direct current. An AC dynamo is preferred over a direct current (DC) dynamo because users of such manual power generators may not realize that a DC dynamo only turns in one direction, and as such, a user may break the hand crank if the dynamo is turned in the wrong direction.

A preferred embodiment of a representative solar panel 101 is adapted to transmit approximately 120 milliamps at a predetermined voltage (or, threshold voltage) needed to overcome the forward bias of the blocking circuit 115 and still charge the internal batteries 117 to the desired voltage.

Blocking circuit 115 is adapted to directionally transmit current from each of the three different power sources to the rest of the electronic circuit 50 while preventing reverse current or current leakage. In one preferred embodiment, blocking circuit 115 comprises one or more blocking diodes in electrical communication with the charge controller circuit 116.

Any charging current or power passing from blocking circuit 115 is then transmitted to the charge control circuit 116. Charge control circuit is preferably controlled by computer 120 to provide a charge to the internal batteries depending upon the status of each solar cell's 101 voltage, the manual power generator's 107 voltage as well as the internal battery's 117 voltage. Moreover, as new digital content is inserted into the system 10, some digital content may be used to modify, change or update the functions of the charge controller circuit 116, thereby allowing for fast and easy modification.

In particular, computer 120 is adapted to continuously sense the voltage level of each internal rechargeable battery 117, and if the voltage level drops below any voltage available from the three available power sources, computer 120 will control transistors within charge control circuit 116 to start charging (or, re-charging) the internal battery 117. In turn, when computer 120 determines that the voltage level battery 117 is adequate, computer 120 controls transistors within charge control circuit 116 to emit a pulsing charge to each internal battery 117 in order to maintain the battery charge while preventing the batteries from being overcharged. In a preferred embodiment, even if the system 10 is off and yet is obtaining power from one of the three available power sources, the charge control circuit 116 (by control of computer 120) will still re-charge the internal batteries 117.

Internal batteries 117 are preferably nickel metal hydride batteries, and optionally, are designed as four 4.8 volt cells at approximately 650 milliamp hours. Those of skill in the art will realize that other battery configurations may be used depending on the operating environment (e.g., extreme heat, extreme cold, extreme humidity, etc.) and yet such other configurations will remain within the spirit and scope of the present invention.

A representative power control circuit 118 incorporates a voltage regulator which allows the present invention to provide power to a pre-selected digital audio decoder or computer 120. Power control circuit 118 is also adapted to detect whether an earphone jack is inserted by the operator, if so, power control circuit 118 employs a microswitch which opens upon the earphone jack being inserted, and will cut off power to the audio amplifier 121 to conserve electricity. A representative power control circuit 118 also may include one or more voltage regulators to obtain different voltages to power different portions the circuit, including providing power for all digital circuits and all analog circuits.

A representative power supply de-coupling circuit 119 is shown in FIG. 5. Power supply de-coupling circuit 119 is adapted to control the internal batteries 117 to provide power to both the digital audio computer 120 and the analog audio amplifier 121. When digital and analog circuits are operated from a single power source, a phenomenon referred to as “ground bounce” occurs which causes distortion in the analog audio output 121. Typical prior art portable audio devices bypass this problem by utilizing separate battery supplies for the digital circuit and the analog circuit. However, the present invention employs one or more modified pi filters that are specifically tuned to the multiple noise generating frequencies characteristic of the digital audio decoder 120 employed in order to de-couple the power source 117 from the analog audio amplifier circuit 121.

Power supply de-coupling circuit 119 may also include one or more inductors and capacitors in frequency matched electronic communication with each other which are adapted to separate analog power from digital power in the present invention. This feature may be needed because, in an audio circuit like the present invention that utilizes both analog and digital circuitry and require power from the same power source, a typical digital clock pulse generates what is commonly called “ground bounce” off of the battery supply that directly affects the analog circuit resulting in an audible “buzz” from the audio speaker. In a preferred embodiment, the inductors and capacitors are selectively frequency matched as a band reject filter to prevent the noise generating characteristics of the digital circuit clock pulse arising from the operation of computer 120.

Microprocessor or computer 120 is preferably a multi-function computer or microcontroller adapted for use as the main control electronics of the present invention. As seen in FIG. 5, computer 120 is in direct or otherwise indirect electronic communication with at least one mechanical or manual power generating means 107, at least one rectifier 113, at least one solar power cell 101, at least one blocking circuit 114, at least one external AC/DC charger 112, at least one blocking circuit 114, at least one charge control circuit 116, at least one rechargeable battery 117, at least one power control circuit 118, at least one power supply de-coupling circuit 119, at least one analog audio amplifier 121, at least one output circuit 122, at least one operator control 125 and at least one waterproof or otherwise water-resistant speaker 123. Further, as discussed below, computer 120 may also be in electrical communication with at least one mass memory storage device or unit adapted to store secure content 124.

In particular, computer 120 is adapted to receive control instructions from an insertable flash memory unit 124. Thus, an operator may control the overall function of the system 100 by electronically storing pre-defined programming code in memory unit 124. When memory unit is inserted into the system 100, computer 120 is adapted to receive the pre-defined programming code from memory unit 124, including receiving any new operational control information stored on memory unit 124.

Other features exist, and are discussed throughout this disclosure. Thus, for example, when the present system is turned off by an operator, computer 120 may be programmed to control power control circuit 118 to prevent power discharge from occurring by any circuit which might consume power (such as, for example, the internal battery 117) while concurrently still allowing the charge controller to provide power to the internal battery 117. This is a useful feature if the present invention will not be used for a long period of time. Those of skill in the art will realize that computer 120 may be programmed to turn off system 100 after a short time frame of non-use (such as 90 seconds, for example). Moreover, due to the nature of the present invention, computer 120 includes a digital to analog circuit which can translate the digital content within memory unit 124 into analog signals for transmission to speaker 123.

Operator control circuit 125 encompasses all operator controllable or visual electronics of the present system 100, and is in electrical communication with computer 120. Thus, for example, operator control circuit 125 may also include volume switches, control buttons, and an operational (e.g., “on/off”) switch. Further, computer 120 may also be programmed to allow the operator control circuit 125 to have a “soft start” feature. This feature will allow the computer 120 to bookmark (or, memorize) the exact location of the digital content when the system 100 is manually powered off so that when an operator resumes operation of the present unit, the computer 120 will resume transmission of the digital data from the location of digital content stored in memory. This is a useful feature, as it allows an operator to resume listening to the digital content from a point where it was last stored in memory.

Moreover, computer 120 may communicate with operator control circuit 125 to pause the transmission of digital content to speaker 123, to play the digital content, or to quickly move from one area of the digital content to another area of the digital content (e.g., skipping, fast forward, reverse).

Computer 120 may also communicate with one or more control buttons within operator control circuit 125. For example, one control button may be assigned to allow an operator to highlight or select the digital content desired (such as a new song stored as digital content on the memory unit 124, a new book stored as digital content on the memory unit 124, or a new chapter of a book stored as digital content on the memory unit 124). When appropriately selected, computer 120 will communicate with memory unit 124 to retrieve the selected digital content stored in memory 124 for transmission to audio speaker 123. Moreover, another control button may be assigned to either fast forward to a later section of the digital content, and another control button may be assigned to reverse to a subsequently section of the digital content. In these cases, depending on the action of the control button, the computer 120 will act accordingly to communicate with memory unit 124 to move to a different location. Another control button may be assigned to pause the digital content being played, and still another control button may be assigned to “play” or “resume play” of the digital content.

LCD display unit (as seen, for example, as element 102 in FIG. 1), within operator control circuit 125 an in electrical communication with computer 120, provides visual information to the operator. Thus, for example LCD display unit may provide a visual indicator to the operator of the text describing the digital content stored in memory unit 124, and the corresponding location of the current digital content stored in memory (illustrated in FIG. 1, for example, as a progress bar). Moreover, LCD display unit 102 may provide an operator with a visual power source indicator, thereby allowing an operator to determine the charge status of the internal battery 117. LCD display unit 102 may also provide an operator with a visual volume indicator, thereby allowing an operator to determine the volume level of the speaker 123 or a corresponding earphone.

Computer 120 may also be adapted to control LCD display unit 102 so that it graphically displays one or more language fonts and/or international icons. This feature is useful to those operators who are illiterate (as icons can be graphically displayed), or otherwise, are only versed in a particular language (such as, for example, where text for Spanish, German, French or other language which might be native to the area of operation can be graphically displayed).

Returning now to FIG. 5, a representative analog audio output 121 is an analog audio amplifier preferably coupled to an output circuit 122. In one preferred embodiment, the analog audio output 121 is a low watt audio amplifier adapted to provide a pre-selected decibel output level desired from the speaker 123 at minimum power consumption. Audio output 121 receives an analog signal from computer's 120 digital to analog converter which corresponds to the digital content stored on memory unit 124. Generally, such analog signals are low level signals or are other wise weak (and therefore, require amplification). Thus, output circuit 122 is adapted to provide the necessary amplification for the analog signal.

As discussed above, output circuit 122 is adapted for the amplification and conditioning of a direct transmission of an analog signal corresponding to the digital content to a speaker 123. Output circuit 122 also includes an output audio jack that can supply an audio signal to an external audio distribution system such as a school, hospital or prison public announcement (PA) system.

Speaker 123 is preferably sized and shaped to provide optimal resonance in a large room or group setting at higher volume levels without overdriving or distorting the speaker 123.

In one embodiment, the data stored on the memory unit 124 is encrypted and compressed according to the Windows Media Audio (WMA) standard offered by Microsoft Corporation of Redmond, Wash. The WMA compression standard provides a higher data compression rating for the storage of voice data, which in turn allows for more data storage at a significantly reduced cost. In turn, encryption is preferably utilized to protect the intellectual property found in the digital content being stored. For further security of property, the memory unit's 124 electronic interface with the system 100 may be changed to a proprietary format, so that the memory unit 124 may only electronically communicate or physically integrate with system 100. Further, in a preferred embodiment, the memory unit 134 is a 256 megabyte (MB) flash memory chip, but the present invention is not limited to this data storage size; rather, the present invention contemplates use of any size of memory that accommodates the purpose and spirit of the present invention. Flash memory is the preferred form of memory because it can easily be reprogrammed with different or new digital content without having to purchase new memory units. Of course, those of skill in the art will realize that other forms of memory units may be utilized (such as hard drives, RAM chips, ASIC chips and the like, for example), all of which are contemplated by the present invention.

In the preferred embodiment, the resonance of the exterior housing is optimized for clarity (at higher volumes) of the digital content while minimizing power consumption from the power source. The resonance is optimized in order to accommodate usage of the present invention in a specified geographic area, so that many listeners may enjoy and learn from the digital content being broadcast. Thus, in one embodiment, 4×6 inch, 8 ohm speakers 123 are utilized having optional waterproof or water-resistant cones.

Optionally, a carrying case (not shown) may be used which is adapted to receive the system 100 and securely retain the system 100 for transport. In one embodiment, the carrying case will have adequate ports (such as for the dynamo and/or for the speaker) which will allow a user to operate the system 100 while concurrently transporting the system.

The present invention may be embodied as a method, system, kit, an apparatus or a device. Other variations and modifications of the present invention will be apparent to those of ordinary skill in the art, and is not limited except by the appended claims. The particular values and configurations discussed above may be varied, and are cited to illustrate particular embodiments of the present invention. It is contemplated that the use of the present invention can involve components having different characteristics as long as the principles disclosed herein are followed.

1. A portable, multi-source powered audio delivery system comprising:
an external housing having a outer surface, a portion of the outer surface being an adjustable and secureably removable surface;
at least one display unit securely retained on the outer surface;
at least one control button securely retained on the outer surface;
at least one speaker secured within the housing and securely retained on the outer surface;
at least one solar panel securely retained on the securely removable surface;
at least one manually generated power source securely retained on the outer surface;
at least one alternating current/direct current (AC/DC) charger;
at least one securely removable, encryptable memory unit adapted to store digital content and operational control data, the housing adapted to receive the memory unit; and
an electronic control circuit having at least one rechargeable battery, the electronic control circuit in electrical communication with each display unit, each control button, each speaker, each solar panel, each manually generated power source and each memory unit, the electronic control circuit adapted to selectively transmit power from each solar panel, manually generated power source or each AC/DC charger to each rechargeable battery, the electronic control circuit further adapted to selectively transmit the digital content from the memory unit to the speaker for audible broadcast.

2. The multi-source powered audio delivery system of claim 2, the electronic control circuit further comprising:
at least one rectifier adapted to convert direct current from the manually generated power source to alternating current;
at least one blocking circuit adapted to directionally transmit alternating current arising from each solar panel, manually generated power source or each AC/DC charger while preventing reverse current, each rectifier being in electrical communication with each blocking circuit;
at least one charge controller adapted to receive alternating current from each rectifier, each rectifier being in electrical communication with each charge controller, each charge controller controlled by the computer to charge the rechargeable battery;
at least one power control circuit in electrical communication with each blocking circuit and each charge controller;
at least one power supply de-coupling circuit adapted to transmit power from each rechargeable battery to the computer and the audio amplifier, each power supply de-coupling circuit further comprising an electrically suppressive means adapted to suppress noise between each rechargeable battery and each audio amplifier circuit; and
at least one output circuit in electrical communication with each audio amplifier, each output circuit adapted to amplify and condition the analog signal;
at least one computer having a digital to analog circuit in electrical communication with each charge controller, each power control circuit, each power supply de-coupling circuit and each output circuit; and
at least one analog audio amplifier in electrical communication with each digital to analog circuit, each analog audio amplifier adapted to provide a pre-selected decibel output level desired from each speaker.

3. The multi-source powered audio delivery system of claim 2 wherein each computer is adapted to monitor any electrical power from each solar panel, each manually generated power source, each AC/DC charger and each rechargeable battery, and dependant upon the power level existing in each rechargeable battery, each computer is further adapted to control the charge control circuit to re-charge each rechargeable battery with power available from each solar panel, each manually generated power source or each AC/DC charger.

4. The multi-source powered audio delivery system of claim 3 wherein each computer is adapted to monitor any electrical power from each solar panel, each manually generated power source, each AC/DC charger and each rechargeable battery, and dependant upon the power level existing in each rechargeable battery, each computer is further adapted to control the charge control circuit to emit a pulsing charge to each rechargeable battery to maintain a pre-determined charge in each rechargeable battery with power available from each solar panel, each manually generated power source or each AC/DC charger.

5. The multi-source powered audio delivery system of claim 4 further comprising a power indicator securely retained on the outer surface.

6. The multi-source powered audio delivery system of claim 4, wherein each memory unit is adapted to store digital data according to the Window Media Audio compression standard.

7. The multi-source powered audio delivery system of claim 4, wherein each memory unit is adapted to physically interface only with and electronically communicate with the system.

8. The multi-source powered audio delivery system of claim 8, wherein each memory unit is selected from the group comprising one or more hard drives, one or more RAM chips, and one or more ASIC chips.

9. The multi-source powered audio delivery system of claim 2 further comprising a carrying case adapted to securely receive the system for transport.

10. A digital content delivery system comprising:
an external housing, at least one display unit, at least one control button, at least one speaker; at least one solar panel, and a power indicator, all securely retained within the housing;
at least one manually generated power source securely retained to the housing, at least one alternating current/direct current (AC/DC) charger interface and at least one securely removable, encryptable memory unit adapted to store digital content and operational control data, the housing adapted to removably integrate with the memory unit; and
an electronic control circuit having at least one computer and at least one rechargeable battery, the electronic control circuit in electrical communication with each display unit, each control button, each speaker, each solar panel, each manually generated power source and each memory unit, the electronic control circuit adapted to selectively transmit power from each solar panel, manually generated power source or each AC/DC charger to each rechargeable battery to maintain operational charge, the electronic control circuit further adapted to selectively transmit the digital content from the memory unit to the speaker for audible broadcast.

11. The digital content delivery system of claim 10 wherein each computer is adapted to monitor any electrical power from each solar panel, each manually generated power source, each AC/DC charger and each rechargeable battery, and dependant upon the power level existing in each rechargeable battery, each computer is further adapted to control the charge control circuit to re-charge each rechargeable battery with power available from each solar panel, each manually generated power source or each AC/DC charger; each computer further adapted to monitor any electrical power from each solar panel, each manually generated power source, each AC/DC charger and each rechargeable battery, and dependant upon the power level existing in each rechargeable battery, each computer is further adapted to control the charge control circuit to emit a pulsing charge to each rechargeable battery to maintain a pre-determined charge in each rechargeable battery with power available from each solar panel, each manually generated power source or each AC/DC charger.

12. The digital content delivery system of claim 11, wherein each memory unit is adapted to store digital data according to the Window Media Audio compression standard.

13. The digital content delivery system of claim 12, wherein each memory unit is adapted to physically interface only with and electronically communicate with the system.

14. The digital content delivery system of claim 13, wherein each memory unit is selected from the group comprising one or more hard drives, one or more RAM chips, and one or more ASIC chips.

15. The digital content delivery system of claim 11 further comprising a carrying case adapted to securely receive the system for transport.

16. An audio system for delivering digital content, the system comprising:
an external housing, a display unit, a plurality of control buttons, a speaker; an adjustable solar panel, at least one manually generated power source securely retained to the housing, an alternating current/direct current (AC/DC) charger interface, all securely retained within and on the housing;
an electronic control circuit having a computer system and at least one rechargeable battery, the electronic control circuit in electrical communication with the display unit, each control button, the speaker, the solar panel, the manually generated power source and a removable memory unit adapted to store digital content and operational control data, the electronic control circuit adapted to selectively transmit power from each solar panel, manually generated power source or each AC/DC charger to each rechargeable battery to maintain operational charge, the electronic control circuit further adapted to selectively transmit the digital content from the memory unit to the speaker for audible broadcast.

17. The audio system of claim 16 wherein each computer system is adapted to monitor any electrical power from each solar panel, each manually generated power source, each AC/DC charger and each rechargeable battery, and dependant upon the power level existing in each rechargeable battery, each computer system being further adapted to control the charge control circuit to re-charge each rechargeable battery with power available from each solar panel, each manually generated power source or each AC/DC charger; each computer system further adapted to monitor any electrical power from each solar panel, each manually generated power source, each AC/DC charger and each rechargeable battery, and dependant upon the power level existing in each rechargeable battery, each computer system being further adapted to control the charge control circuit to emit a pulsing charge to each rechargeable battery to maintain a pre-determined charge in each rechargeable battery with power available from each solar panel, each manually generated power source or each AC/DC charger.

18. The audio system of claim 17, the electronic control circuit further comprising:
at least one rectifier adapted to convert alternating current from the manually generated power source to direct current;
at least one blocking circuit adapted to directionally transmit alternating current arising from each solar panel, manually generated power source or each AC/DC charger while preventing reverse current, each rectifier being in electrical communication with each blocking circuit;
at least one charge controller adapted to receive direct current from each rectifier, each rectifier being in electrical communication with each charge controller, each charge controller controlled by the computer to charge the rechargeable battery;
at least one power control circuit in electrical communication with each blocking circuit and each charge controller;
at least one power supply de-coupling circuit adapted to transmit power from each rechargeable battery to the computer and the audio amplifier, each power supply de-coupling circuit further comprising an electrically suppressive means adapted to suppress noise between each rechargeable battery and each audio amplifier circuit; and
at least one output circuit in electrical communication with each audio amplifier, each output circuit adapted to amplify and condition the analog signal;
wherein each computer system has a digital to analog circuit in electrical communication with each charge controller, each power-control circuit, each power supply de-coupling circuit and each output circuit; and
at least one analog audio amplifier in electrical communication with each digital to analog circuit, each analog audio amplifier adapted to provide a pre-selected decibel output level desired from each speaker at minimum power.

19. The audio system of claim 18, wherein each memory unit is adapted to store digital data according to the Window Media Audio compression standard.

20. The audio system of claim 19, wherein each memory unit is adapted to physically interface only with and electronically communicate with the audio system.
